(19) United States
(12) Patent Application Publication
(10) Pub. No.: US 2011/0107204 A1
(43) Pub. Date: May 5, 2011

(54) AUTOMATED DOCUMENT ASSEMBLY WITH OBSCURING

(75) Inventors: Grahame K. Cohen, London (GB); Matthew Kogan, Hertfordshire (GB); Nicola Casali, Hertfordshire (GB)

(73) Assignee: EPOQ GROUP LTD., Edgware, Middlesex (GB)

(21) Appl. No.: 12/988,762

(22) PCT Filed: Apr. 21, 2009
(86) PCT No.: PCT/IB2009/005321

§ 371 Date: Dec. 8, 2010

Related U.S. Application Data
(60) Provisional application No. 61/046,864, filed on Apr. 22, 2008.

(51) Int. Cl. G06F 17/21

(52) U.S. Cl. 715/243

(57) ABSTRACT

A document assembly system includes a storage element (506) for storing one or more document templates. The document templates includes at least one document portion and one or more obscuring parameters associated with the document portion and the obscuring parameters specify at least one obscuring method for the document portion. The system also includes a processing element (508) communicatively coupled to the storage element. The processing element is configured for assembling a user document based on at least one of the document templates and at least one input from a user input device (502) and electronically publishing the assembled user document, where the published user document is obscured according to the obscuring parameters associated with the template and permissions associated with the user input device.

### CROSS REFERENCE TO RELATED APPLICATIONS

This application claims the benefit of U.S. Provisional Patent Application Ser. No. 61/046,864 entitled “DOCUMENT AUTOMATION”, filed Apr. 22, 2008, which is herein incorporated by reference in its entirety.

### FIELD OF THE INVENTION

The invention relates to automated document assembly, and more specifically to systems and methods for automated document assembly with obscuring.

### BACKGROUND

Many document assembly systems are typically unsophisticated systems providing text replacement of variables using a questionnaire or questions within the document itself. The variables are then placed into the document at the specified locations. More sophisticated automated document assembly systems usually include two parts, an authoring application and a client facing questionnaire application. In general, both the authoring application and the questionnaire are typically configured to link to existing word-processing packages which handle the text and its formatting.

Document assembly systems with authoring applications generally allow publishing users to create a series of document text, variables, logic and help text that combine into a file or series of files that can be used to present a questionnaire to the user. Essentially this questionnaire acquires end user data that enables it to branch down different logic pathways, enabling and disabling certain questions thereby capturing further specific data based on previous questions asked. Generally, for most automated document assembly systems, at the end of the process the captured data and logic is compiled into a finished document for the end user.

### SUMMARY

This Summary is provided to present a summary of the invention to briefly indicate the nature and substance of the invention. It is submitted with the understanding that it will not be used to interpret or limit the scope or meaning of the claims. Embodiments of the invention describe systems and methods for automated document assembly with obscuring.

In a first embodiment of the invention, a method of authoring a document for a document assembly system is provided. The method includes identifying one or more document portions for inclusion in the document template and selecting at least one obscuring method for at least one of the document portions. The method also includes generating one or more obscuring parameters for the one document portion based on the selected obscuring method and storing a document template including the document portions and the obscuring parameters, where a document based on the document template is obscured according to the stored obscuring parameters during electronic publication.

In a second embodiment of the invention, a method of assembling a document in a document assembly system is provided. The method includes selecting a document template, the document template including one or more document portions and one or more obscuring parameters associated with the document portions, and the obscuring parameters specifying at least one obscuring method for at least one of the document portions. The method also includes assembling a user document based on the document template and at least one input from a user input device and electronically publishing the assembled user document, where the publishing includes generating a modified version of the user document obscured based on the obscuring parameters and permissions associated with the user input device.

In a third embodiment of the invention, a document assembly system is provided. The system includes a storage element for storing one or more document templates, the document templates including at least one document portion and one or more obscuring parameters associated with the document portion, the obscuring parameters specifying at least one obscuring method for the document portion. The system also includes a processing element communicatively coupled to the storage element. The processing element is configured for assembling a user document based on at least one of the document templates and at least one input from a user input device and electronically publishing the assembled user document, where the published user document is obscured according to the obscuring parameters associated with the template and permissions associated with the user input device.

In a fourth embodiment of the invention, a document assembly method is provided. The method includes the step of selecting a document template, where the document template includes one or more document portions and one or more obscuring parameters associated with the document portions and the obscuring parameters specify at least one obscuring method for at least one of the document portions. The method also includes assembling a user document based on the document template and at least one input from a user input device and electronically publishing the assembled user document, wherein the publishing comprises generating an obscured version of the user document based on the obscuring parameters and permissions provided by a user at the user input device. In the method, the specified obscuring method replaces the document portions associated with the obscuring parameters with one or more obscuring features in the obscured version of the user document.

### BRIEF DESCRIPTION OF THE DRAWINGS

FIG. 1 is an overview of the various processes performed by the various elements in an automated document assembly system configured in accordance with an embodiment of the invention.

FIG. 2 shows the steps in an exemplary method for authoring document templates in accordance with an embodiment of the invention.

FIG. 3A-3E shows the results of exemplary obscuring methods in accordance with some embodiments of the invention.

FIG. 4 shows the steps in an exemplary method for assembling documents using document templates specifying obscuring in accordance with an embodiment of the invention.

FIG. 5 shows a system depicting an exemplary arrangement of components for assembling documents according to an embodiment of the invention.

FIG. 6 is a schematic diagram of a general purpose computer system for executing a set of instructions that, when executed, can cause the computer system to perform one or more methodologies and procedures in accordance with an embodiment of the invention.

### DETAILED DESCRIPTION

The invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

In general, many conventional online document automation systems generally include a question and answer dialogue. Once this dialogue is completed, the document is assembled and the user is prompted to provide credentials for accessing the document the assembled product (e.g., a payment). However, an issue with the implementation of many conventional document assembly systems is how to persuade users to purchase an assembled document. For example, many users will not purchase such a document unless they are allowed to preview the document. Unfortunately, this results in several problems. First, if a user wishes to see the finished or current iteration of the document, the user generally must request the server to compile the document, introduces latency into the document display refresh process. Second, if the document is accessible before purchase, the end user may be able to copy it without paying for document.

In order to overcome the limitations of conventional on-line document assembly systems, embodiments of the invention provide systems and methods for displaying assembled documents prior to purchase or access by selectively obscuring one or more parts of the electronically published document so that unqualified users are able to engage with the application. That is, end users can preview the document to generally determine its content, but will not be able to easily view or access one or more portions of the document until they are qualified or authorized. For example, the document remains obscured until the end user pays for the document or provides a password. However, the invention is not limited in this regard and any method for authorizing user access can be used with the various embodiments of the invention. In some embodiments, this obscuring is configured to obscure the same document portions regardless of the position of such portions in the end user's display. For example, if the end user has the flexibility of resizing a web browser window presenting the document or content is removed or added during document assembly, text wrap can vary during resizing. In such embodiments of the invention, the same text would remain obscured regardless of changes in its position due to window resizing. As described above, one issue with conventional on-line document assembly systems is the latency in refreshing of the assembled document when the document is updated. Therefore, in some embodiments of the invention, the document assembly process can be performed using local resources, remote resources, or any combination thereof to improve latency issues.

The term “electronically publishing”, as used herein, refers to electronic delivery or presentation of a document. Electronic publishing can include not only delivery of a document to a display device on an end user terminal, but can also include delivery of a document to other electronic devices, including mass storage devices or devices for generating hardcopies (e.g., a printer). Additionally, a document can be delivered to a local device, a remote device, or any combination thereof, depending on the configuration and/or type of end user device.

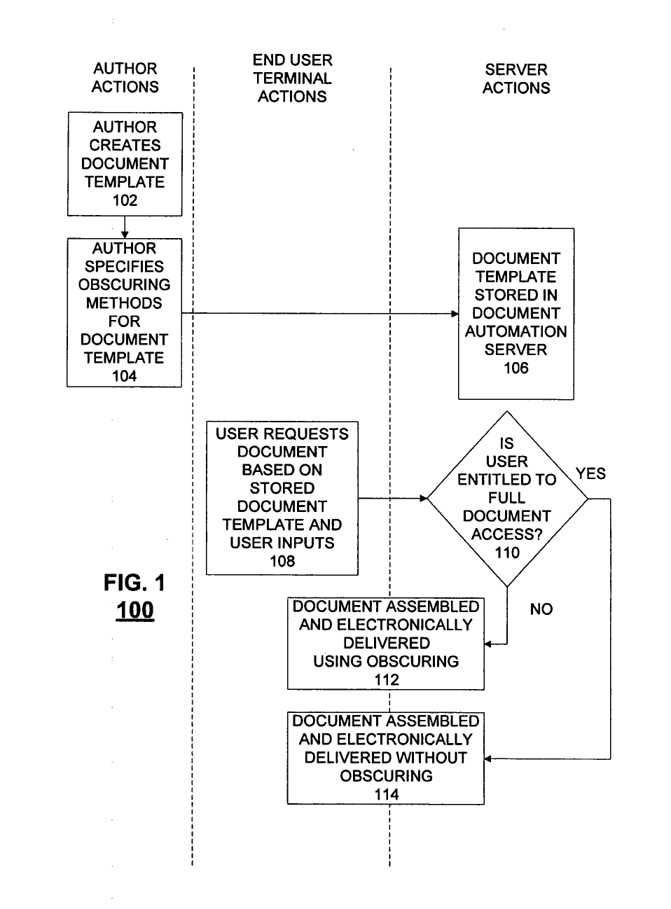

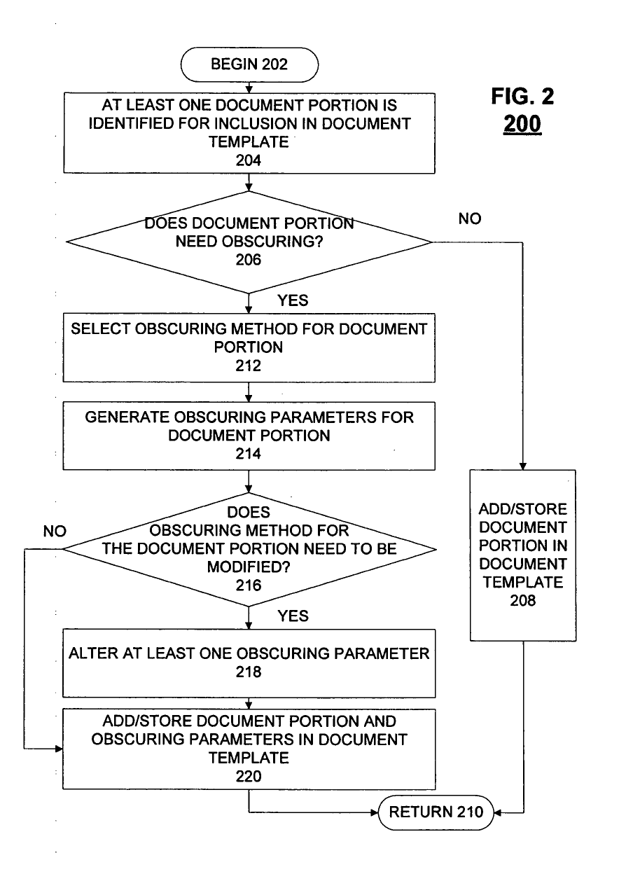

As described above, embodiments of the invention provide online systems and methods for presenting a document during its assembly in which elements of the document are obscured for unqualified users and un-obscured for qualified users. In particular, the various embodiments of the invention provide for specifying such obscuring by providing instructions/parameters for obscuring within the document templates to be used during the document assembly process. An overview of the operation of such systems and methods is shown in FIG. 1. FIG. 1 is an overview of the various processes performed by the various elements in an automated document assembly system configured in accordance with an embodiment of the invention. As shown in FIG. 1, actions are divided among three areas: author actions (actions by document template authors), end user terminal actions (actions at a terminal requesting document assembly), and server actions (actions at a document automation server). Initially, an author creates a document template for the document assembly system, as indicated in block 102. This document template can specify one or more document portions that specify document text fields, document non-text fields, and document generation fields. For example document generation fields can include questions, rules, formulas, calculations, or blocks of logic necessary for generating a document using the document template. After the author creates the document template at block 102, the author can select obscuring methods for the document template at block 104. That is, for one or more document portions of the document template, the author can select one or more obscuring methods. Finally, a document template, specifying the obscuring methods, can be stored at block 106 in a storage element of the document assembly system for later use. The steps for authoring a document template will be described below in greater detail with respect to FIG. 2.

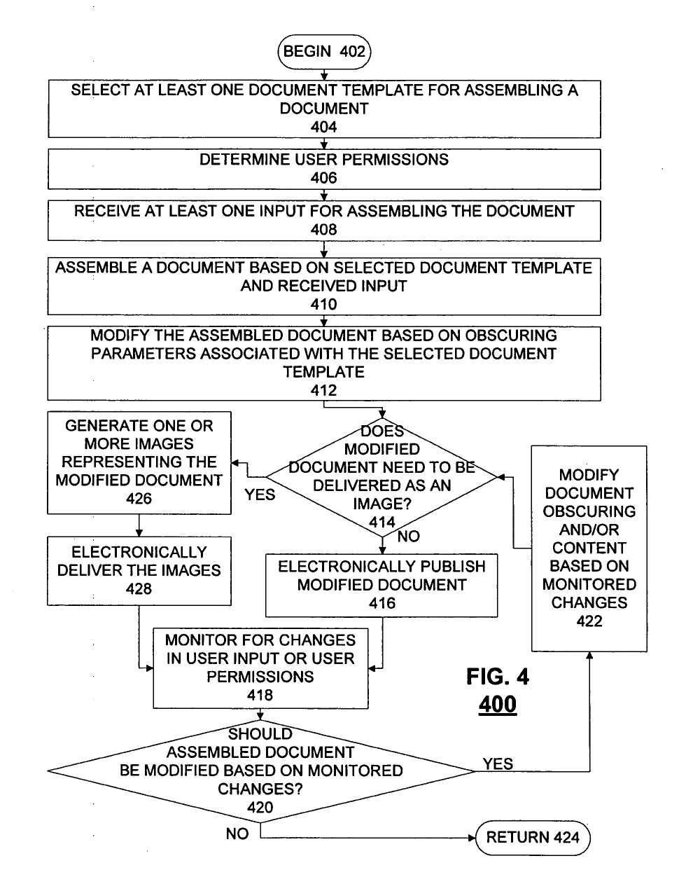

Once document templates are stored at block 106, they can be used to create documents. This process typically begins at an end user terminal, as shown in FIG. 1. At block 108, the end user can request a document be assembled, based on a document template and one or more user inputs. The server can receive this request and determine at block 110 whether the user is entitled to full access to the document during the assembly process. For example, the server can determine whether or not the user has paid for the document assembly service. If the server determines full access is not permitted, the document is assembled and electronically delivered using obscuring at block 112. If the server determines full access is permitted, the document is assembled and electronically delivered without using obscuring at block 114. As noted above, in some embodiments of the invention, real-time updating of the document during the assembly process can be provided. Therefore, as shown in FIG. 1 the assembly processes at steps 112 and 114 can be performed at the server, at the end user terminal, or any combination thereof to improve latency issues. The steps for assembling a document using a document template will be described below in greater detail with respect to FIG. 4.

Although some exemplary embodiments described herein will be described in terms of XML, JavaScript, and other particular computer languages, the embodiments of the invention are not limited in this regard. One of ordinary skill in the art will recognize that the various methods and systems described herein can also be implemented using any other type of programming language, scripting language, and/or web page authoring language.

As described above in FIG. 1, document templates are generated using an authoring process, including defining of the document and the obscuring to be applied. An exemplary method for authoring documents is shown in FIG. 2. FIG. 2 shows the steps in an exemplary method 200 for authoring document templates in accordance with an embodiment of the invention. Method 200 begins at block 202 and continues to block 204. At block 204, at least one document portion is identified for inclusion within a document template. That is, an author can enter the information for the document template. The document portions can include static text fields, variable text fields, conditional text fields, document logic, help text for completing a questionnaire, questions for assembly of a document, rules for processing data for the document, validators, cross-references to other parts of the same document, other documents, and document templates, and user guides or other reference information associated with the document portion or the document template. The term “validator”, as used herein, refers to a rule that defines the set of valid answers to a question, one or more error messages to return to the end-user if their answer is invalid, and logic for determining whether or not assembly may continue in response to invalid answers. Additionally, the document portions can include hyperlinks, bookmarks, loop-repeated group of questions, and images or graphics. However, the invention is not limited to these document portions and can include any other number of document portions.

Once the document portions for the document template are identified at block 204, method 200 can determined at block 206 whether obscuring for the document portions is needed. For some document portions, such as logic, obscuring is generally not required since these document portions are used internally and are typically not visible to the end user. Other portions, such as questions or help text, need to be seen by the end user and therefore are also not necessary to obscure. Accordingly, at block 208, these document portions can be added or stored in the document template. Method 200 can then return to previous processing at block 210, including repeating block 206 to determine whether obscuring is needed for other document portions. Some document portions, such as some static or conditional text fields can contain valuable information which the author may not wish to disclose without payment. Accordingly, for these document portions, block 206 can determine that obscuring is needed and method 200 can proceed to block 212.

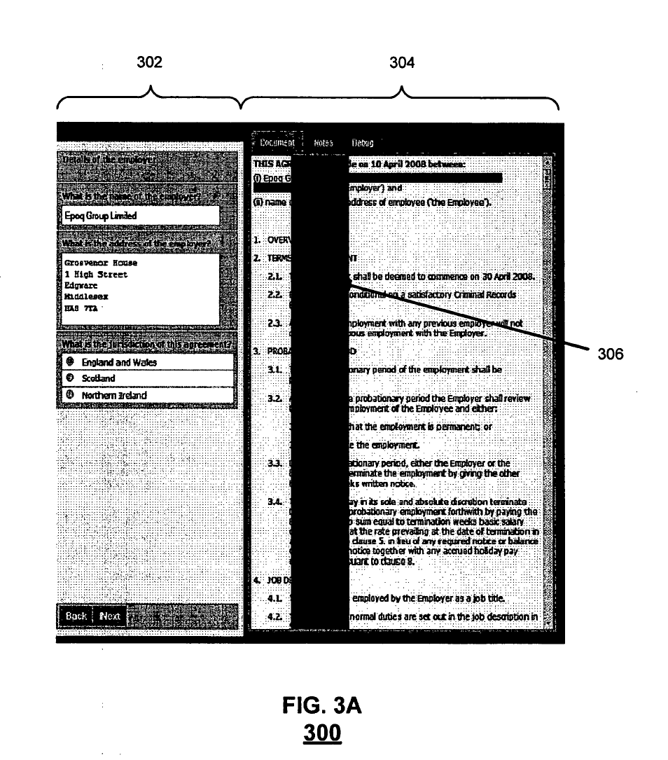

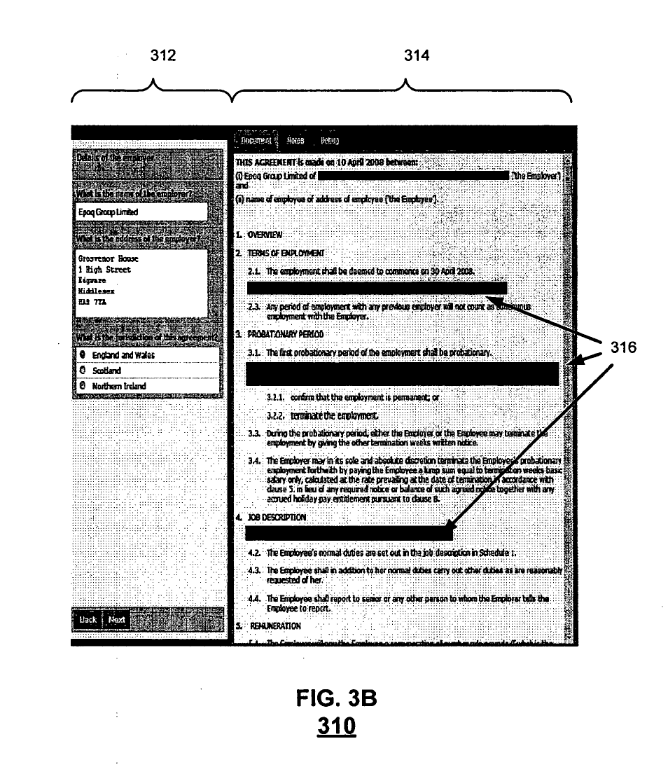

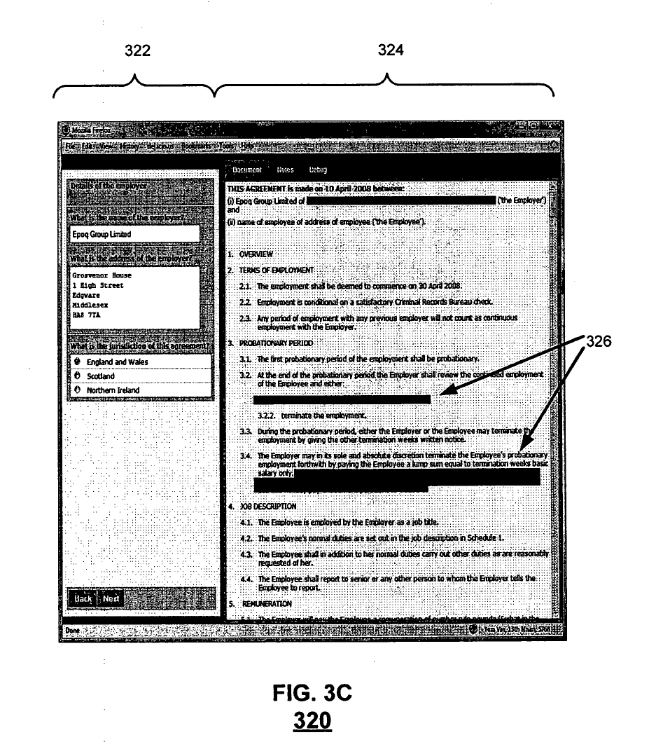

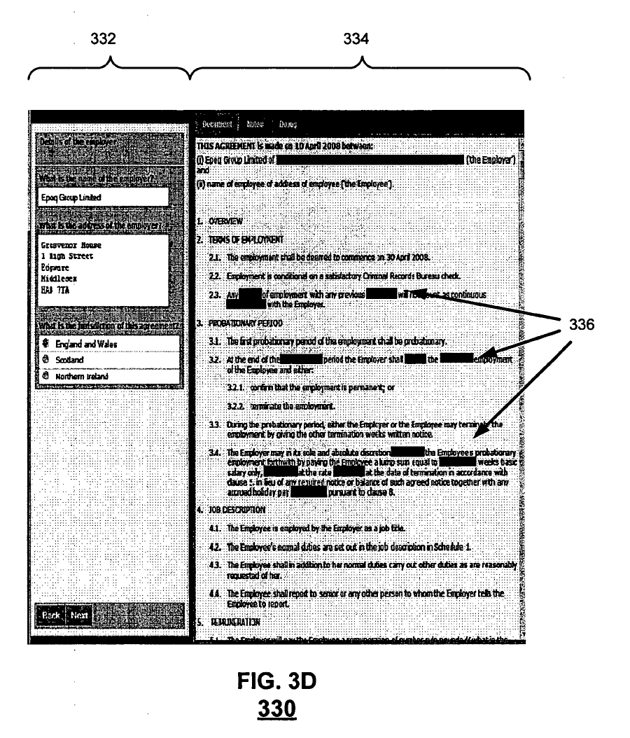

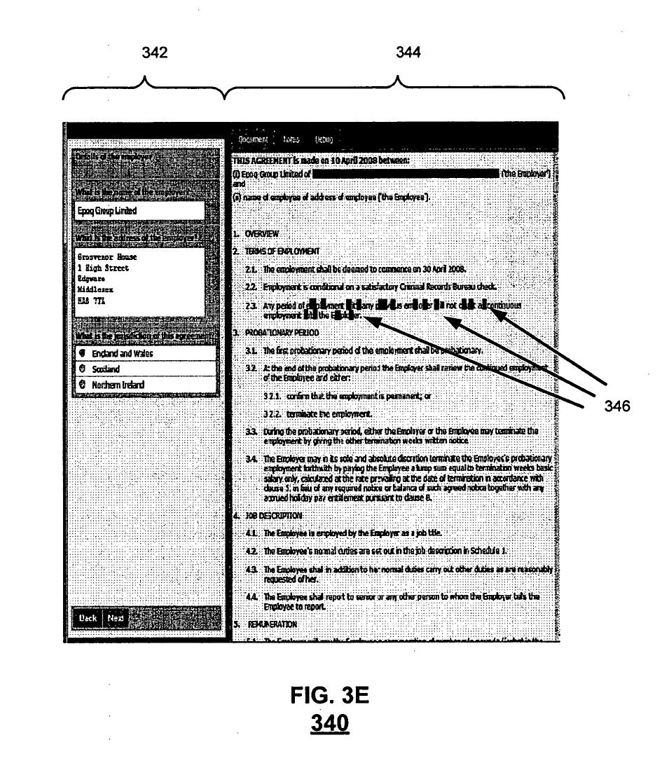

At block 212, the obscuring method can be selected. That is, an obscuring method can be selected that specifies how the document portion is to be obscured. Some exemplary obscuring methods are illustrated in FIGS. 3A-3E. For example, an obscuring scheme can be selected at block 212 in which an area of the document is obscured. This is illustrated in FIG. 3A. FIG. 3A shows a display 300 at an end user terminal, such as web browser/client interface of a document assembly system. As shown in FIG. 3A, display 300 can include questionnaire portion 302 and document portion 304. Display 300 also includes an obscuring feature 306. In one embodiment, an opaque feature is superimposed over a document portion 304. That is, a single obscuring area, such as a tiled graphic, can be provided that covers a strategically chosen portion of the document. In another embodiment, the feature is integrated into the document portion 304. That is, the single obscuring area obscures a strategically chosen portion of the document. An example of the result of providing an obscuring area is shown in FIG. 3A.

In FIG. 3A, a single bar running vertically down the length of the document can be provided that is close enough to the margin to consistently obscure the first few words of each paragraph of the text even if the document is resized. However, for short documents this method may not be enough to successfully prevent an unqualified user from accessing the entire text of the document, as the user could infer the missing words using resizing to reveal those not in the first line of a paragraph.

In other embodiments, an obscuring method can be selected at block 212 that results in obscuring of one or more characters in the text portions of the assembled document being displayed. This is illustrated in FIGS. 3B-3E. For example, FIG. 3B illustrates a method in which selected paragraphs can be obscured. Similar to FIG. 3A, FIG. 3B shows a display 310 at an end user terminal. Display 310 can also include questionnaire portion 312 and document portion 314. However, display 310 instead includes one or more paragraph obscuring features 316 that obscure strategically chosen portions of the paragraphs of the document. In some embodiments, the author can be requested to select a percentage or a number of paragraphs of the document to obscure. However, the invention is not limited in this regard and the number of paragraphs being obscured can be pre-defined by the document assembly system. The document assembly system can then randomly or systematically select which paragraphs to obscure. In some cases, documents may have few or no static paragraphs. That is, many paragraphs are only added to an assembled document in response to answers to the questionnaire. Accordingly, if the author specifies a minimum number of obscured paragraphs for the document template, the system can be configured to include logic in the final document template selected to obscure critical or key paragraphs specified by the author and then randomly select other paragraphs for obscuring to provide the desired amount of obscuring in the assembled document. However, paragraph obscuring may not sufficiently protect short documents or may hide too much information to keep the context clear against the questionnaire.

Another possible selection at block 212 is an obscuring method in which selected sentences are obscured, as shown in FIG. 3C. FIG. 3C shows a display 320 at an end user terminal. As shown in FIG. 3C, display 320 can also include questionnaire portion 322 and document portion 324. Display 320 also includes one or more sentence obscuring features 326 that obscure strategically chosen sentences of the document. In this method, the author can also be requested to select a number or percentage of the sentences in the document to obscure. However, the invention is not limited in this regard and the number of sentences to be obscured can be pre-defined by the document assembly system. The document assembly system can then randomly or systematically select which sentences to obscure. In some cases, documents may have few or no static sentences. Accordingly, sentences can be selected for obscuring in a similar fashion as described above for paragraphs with respect to FIG. 3B. However, sentence obscuring may also not sufficiently protect short documents or may hide too much information to keep the context clear against the questionnaire.

Yet another possible selection at block 212 is an obscuring method in which selected words are obscured, as shown in FIG. 3D. FIG. 3D shows a display 330 at an end user terminal. As shown in FIG. 3D, display 330 can also include questionnaire portion 332 and document portion 334. Display 330 also includes one or more word obscuring features 336 that obscure strategically chosen words of the document. In this method, the author can also be requested to select a number or percentage of the words in the document to obscure. However, the invention is not limited in this regard and the number of words to be obscured can be pre-defined by the document assembly system. The document assembly system can then randomly or systematically select which words to obscure. In some cases, documents may have few or no static words. Accordingly, words can be selected for obscuring in a similar fashion as described above for paragraphs with respect to FIG. 3B. This method can be effective to protect even very short documents, as the general context of the document is ascertainable, but would still require a significant amount of effort by the end user to replace the obscured words to produce a copy of the assembled document.

Still another possible selection at block 212 is an obscuring method in which selected characters, such as individual letters, numbers, and symbols, are obscured, as shown in FIG. 3E. FIG. 3E shows a display 340 at an end user terminal. As shown in FIG. 3E, display 340 can also include questionnaire portion 342 and document portion 344. Display 340 also includes one or more character obscuring features 346 that obscure strategically chosen characters of the document. In this method, the author can also be requested to select a number or percentage of the characters in the document to obscure. However, the invention is not limited in this regard and the number of characters to be obscured can be pre-defined by the document assembly system. The document assembly system can then randomly or systematically select which characters to obscure. In some cases, documents may have few or no static characters. Accordingly, characters can be selected for obscuring in a similar fashion as described above for paragraphs with respect to FIG. 3B. This method can also be effective to protect even very short documents, as the general context of the document is ascertainable, but would still require a significant amount of effort by the end user to replace the obscured characters to produce a copy of the assembled document.

Referring back to FIG. 2, once the obscuring method for the document portion is selected at block 212, a set of obscuring parameters for the document portion can be generated at block 214. That is, a set of parameters are generated that describe how the content of the document portion is to be obscured based on the selected obscuring method. For example, the parameters can specify the position of each obscuring feature, the width of the feature, and the color and transparency of the feature. Additionally, parameters can specify the overlaying technique to be used for generating the obscuring feature. That is, the type of feature to be used for obscuring the portion of the document and how it is integrated into the document. In some embodiments, a graphic overlaying technique can be used. That is a tiled graphic can be used to blot out the portion of the document to be obscured. Alternatively, one or more images can be superimposed and/or incorporated into the document to obscure one or more portions of the document. In another embodiment, a character modifying technique can be used. That is, the areas to be obscured can have the characters of the document replaced. In some cases, the same character can be used throughout the document to provide obscuring. In other embodiment, one or more randomly selected characters can be used.

In some embodiments, the overlaying technique simply provides obscuring features that do not modify the content of the document delivered to the end user. That is, the entire content of the document is present with the strategically selected portions being covered by one or more opaque obscuring features, as described above with respect to FIGS. 3A-3E. Although such an approach provides obscuring, an unqualified end user may still be able to bypass the obscuring features and retrieve the underlying content. In some embodiments of the invention, the document can therefore be further secured by configuring the obscuring features to completely replace the obscured content. That is, the obscured content is removed from the document delivered to the end user. Therefore, even if the obscuring features are removed by an unqualified end user, the document will still lack the portion of the document being obscured by the obscuring features. Accordingly, the obscuring parameters can be configured to further specify removal of obscured content from the document being displayed to the end user.

Additionally, the obscuring parameters can be configured to be static with respect to the obscured content. That is, the same content is always obscured, regardless of its position in the document or a document session. Accordingly, the same content remains obscured regardless of resizing of a browser or other application showing a preview version of the document. Additionally, if the document is closed and opened at a later time an unqualified user, the obscuring is not changed from session to session.

After the obscuring parameters for the document portion are generated at block 214, method 200 can determine whether the parameters need to be modified at block 216. In some cases, an author may wish to customize the obscuring method currently selected for a particular document template. For example, if the author initially allows content for obscuring to be selected randomly, the author may review the content and determine that additional content needs to be obscured. In another example, the author may review the content being obscured and may determine that it will be difficult for the end user to interpret the content without some portions of the content being visible. In other words, the author can select portions for obscuring based on a pre-defined obscuring method, by selecting specific portions of the document template, using any combination thereof.

Accordingly, if the obscuring needs to be modified at block 216, the method 200 proceeds to block 218, where at least one of the obscuring parameters is altered. After block 218 or if no modification of the obscuring is needed at block 216, method 200 proceeds to block 220. At block 220, the document portion and the associated obscuring parameters are added or stored in the document template. Method 200 then proceeds to block 210 to resume previous processing, including repeating method 200.

As described above in FIG. 1, once document templates are stored in a document assembly system, an end user can access the document template to assemble a document. An exemplary method for assembling documents is shown in FIG. 4. FIG. 4 shows the steps in an exemplary method 400 for assembling documents using document templates specifying obscuring in accordance with an embodiment of the invention. Method 400 begins at block 402 and continues to block 404. At block 404, at least one document template is selected for assembling a document. That is, the end user can identify the document template, or templates, or type of document to be assembled. Any methods for selecting a document template or selecting a type of document can be used in the various embodiment of the invention. Separately or concurrently with block 404, method 200 can determine user permissions at block 406. That is, method 400 can determine if the user is qualified to view any content marked for obscuring in the document templates. In other words, has the end user already paid for the document or is qualified for any other reason (e.g., a subscriber or an internal user).

Afterwards, at least one input can be received at block 408 for assembling the document. For example, the end user can begin to provide answers to the questionnaire. Afterwards, based on document template selected at block 404 and the inputs at block 406 and 408, the document can be assembled at block 410. As described above and below, the assembly of the document can be performed using local resources, remote resources, or any combination thereof. An exemplary embodiment using local and remote resources will be described below in the “Example” section. After or during document assembly, the document can then be modified, if necessary, at block 412, based on the obscuring parameters for the document template. That is, if the user permissions specify the user is not qualified, the obscuring parameters are applied to the assembled document.

Once the document is assembled at block 410 and modified at block 412 (if necessary) method 400 can determine at block 414 whether the document needs to be delivered in an image format. That is, in some cases, it can be easier to configure the end user terminal to show an image of the document for end user review, rather that a text version of the document. Additionally, such a version can be used to increase protection of the content, as text is typically more difficult to directly copy from an image than a text-based document. If the document does not need to be delivered as an image at block 414, the document can be electronically published at block 416. That is, the document can be delivered electronically to the end user terminal. The document file or a list can then be displayed on a display device of the end user terminal or output to another device, such as a printer.

As described above, the document can be assembled in real-time. That is, the content of the document can vary depending on changes in user inputs. Additionally, the user permissions may change (i.e., the user provides payment for the document) during the document assembly process. Accordingly, method 400 can monitor for such changes at block 418. If the document needs to be modified based on such changes, method 400 can proceed to block 422. At block 422, the document content and/or obscuring can be changed based on the changes detected at block 420 and electronic publishing is repeated beginning at block 414. The changes to the document can be provided to the end user as a document file or a list of changes, such as an XML update. That is, in some embodiments of the invention, only a list of the changes to be integrated in to the document are delivered. In some embodiments, the changes can specify only that some of the obscuring be removed. For example, in the case of users with different authorization levels provided by an organization, the organization may wish to limit access to some types of critical content. In another example, an end user qualified to access some types of documents (e.g., a subscriber) may try to add content to a document that he is unqualified to access. Accordingly, this additional content will remain obscured until the end user is qualified for the additional content (e.g., pays or accepts additional charges). If no changes are necessary at block 420, method 400 can proceed to block 424 and resume previous processing, including repeating method 400 starting at block 418 to monitoring for other changes.

As described above, in some embodiments, the document can be delivered in an image or a page description format as opposed to a text-based document. Accordingly, if at block 414 it is determined that the modified document needs to be delivered as an image, method 400 proceeds to block 426. At block 426, one or more images representing the current version of the assembled document are generated. For example, in one embodiment, the images can be in the portable document format (PDF) developed by Adobe Systems Incorporated. However, the invention is not limited in this regard and document images can be in other formats, including page description formats (e.g.,XML, ODA, Postscript) or image formats (e.g., JPEG, TIFF, RAW, PNG, GIF, and BMP). However, the invention is not limited to solely these formats and any type of image format or page description format, including any other editable and/or fixed document formats, can be used in the various embodiments of the invention.

Afterwards, the images are electronically delivered at block 428. Similar to the assembly process described above, the image generation process can occur using local resources, remote resources, or any combination thereof. In some embodiments of the invention, to reduce latency during updating of the document, the image delivery process can be tailored. For example, in a document containing many pages, only images of the pages being altered can be generated and delivered to the end user. In another example, the images can be generated using local resources while the document is updated at a remote location. In such embodiments, the document is delivered to the end user terminal, but the end user can be denied direct access to the assembled document. However, since image files are generally greater in size than document files, latency between the remote and local system is typically reduced if the image files are generated remotely. Once the images are delivered at block 428, method 400 can proceed to block 418, as previously described, and continue method 400.

Although FIG. 4 shows one embodiment of steps in an exemplary method of assembling documents using obscuring, the various embodiments of the invention are not limited in this regard. In other embodiments of the invention, a method for assembling documents using document templates specifying obscuring can include more or less steps than those shown in FIG. 4. Additionally, the various embodiments of the invention are not limited to order the steps shown in FIG. 4 and any other order of steps can be used in the various embodiments of the invention.

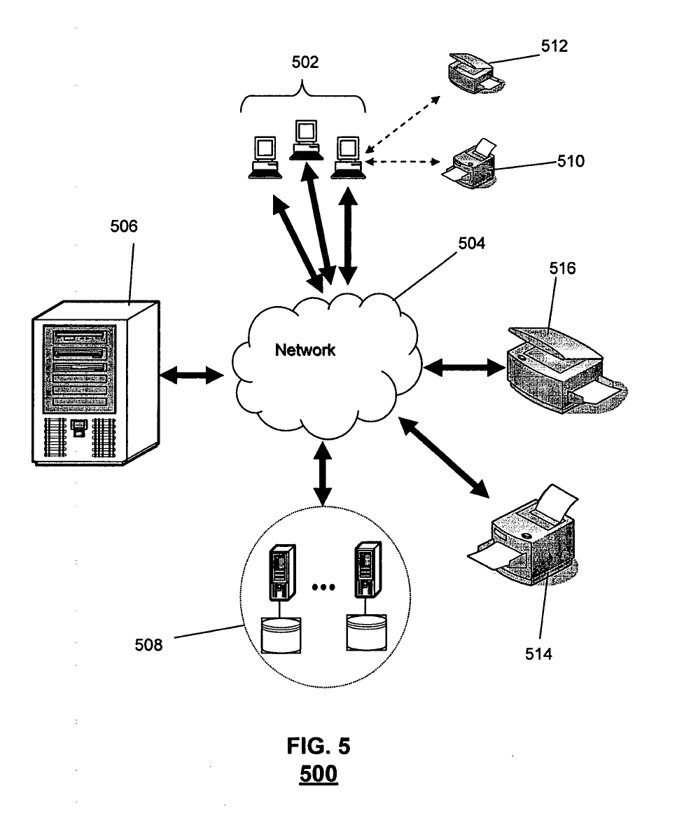

As described above, the various embodiments of the invention can be implemented in a local, remote, or distributed networked fashion. For example, FIG. 5 shows a system 500 depicting an exemplary arrangement of components for assembling documents according to an embodiment of the invention. The system can comprise various types of computer systems and devices, including, but not limited to, a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device.

For example, system 500 can include one or more entry units 502 coupled to network 504. Entry units 502 can include any type of single or multimode computer systems, including, by way of example and not by limitation, a cell phone, a personal computer or laptop, or personal digital assistant capable of supporting wire line and/or wireless communication technologies. The system 500 can also include a processing unit 506 coupled to network 504. In the various embodiments, the processing unit 506 can be implemented as one or more centralized or distributed computer systems, as described below. Furthermore, the system 500 can include one or more computer systems configured as remote databases 508 for storing form data, template data, or any other data for use with system 500. In the various embodiments, the entry units 502 can be configured to operate using a computer program installed in the entry units 502. However, in other embodiments, the entry units can be configured to operate using client software provided by the processing unit 506 or another server. This can allow a user to access the processing unit 506 from any type of entry unit 502 connected to the network.

In some embodiments, a printer 510 and a scanner 512 can be directly coupled to a single entry unit 502 for printing and submitting assembled documents, document templates, or document portions for document templates. However, in other embodiments, such resources can be shared and a network-based printer 514 and a network-based scanning device 516 can instead be coupled to the network 504 to provide printing and scanning functionality. Both the printer 514 and the scanner 516 can be configured to be coupled directly to the network 504 or can be coupled to the network via a server or other computer system coupled to the network 504. In some embodiments, a combination of locally and remotely coupled scanners and printers can also be used.

In the illustrated embodiment, FIG. 5 depicts the various components of system 500 as discrete components coupled to the network 504. However, it is also within the scope of the invention to combine the functions of one or more of these components into a single computer system or to distribute tasks performed by one or more of the components of system 500 over multiple computer systems.

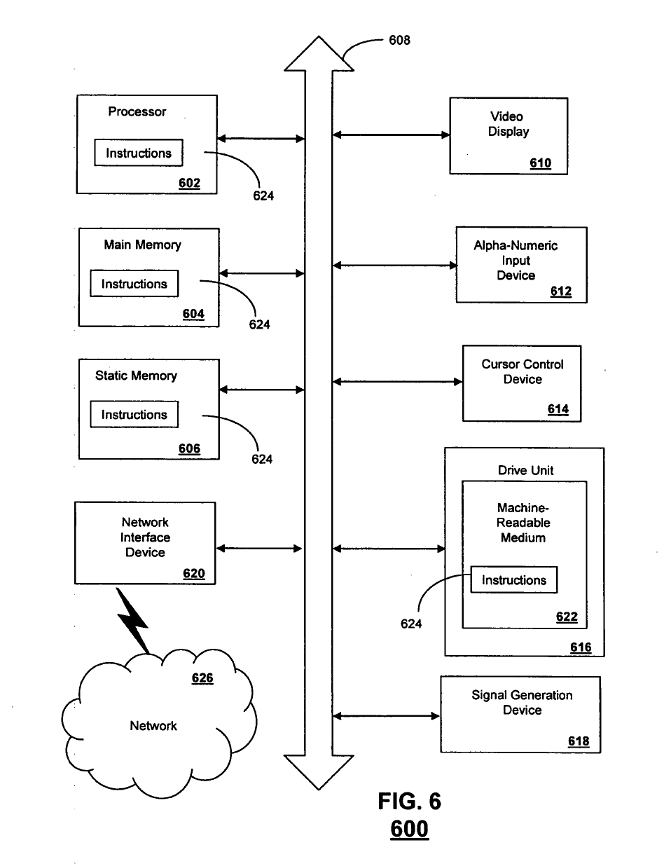

FIG. 6 is a schematic diagram of a general purpose computer system 600 for executing a set of instructions that, when executed, can cause the computer system 600 to perform one or more of the methodologies and procedures described above. In some embodiments, the computer system 600 operates as a standalone device. In other embodiments, the computer system 600 can be connected (e.g., using a network) to other computer systems. In a networked deployment, the computer system 600 can operate in the capacity of a server or a client developer machine in server-client developer network environment, or as a peer machine in a peer-to-peer (or distributed) network environment.

The computer system 600 can include a processor 602 (such as a central processing unit (CPU), a graphics processing unit (GPU, or both), a main memory 604 and a static memory 606, which communicate with each other via a bus 608. The computer system 600 can further include a display unit 610, such as a video display (e.g., a liquid crystal display or LCD), a flat panel, a solid state display, or a cathode ray tube (CRT)). The computer system 600 can include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 can include a computer-readable storage medium 622 on which is stored one or more sets of instructions 624 (e.g., software code) configured to implement one or more of the methodologies, procedures, or functions described herein. The instructions 624 can also reside, completely or at least partially, within the main memory 604, the static memory 606, and/or within the processor 602 during execution thereof by the computer. system 600. The main memory 604 and the processor 602 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 624 or that receives and executes instructions 624 from a propagated signal so that a device connected to a network environment 626 can send or receive voice and/or video data, and that can communicate over the network 626 using the instructions 624. The instructions 624 can further be transmitted or received over a network 626 via the network interface device 620.

While the computer-readable storage medium 622 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The term “wireline” shall accordingly be taken to include, but not be limited to wire-based communications using xDSL, cable, or PSTN telephony interfaces for communicating with data networks, which can include hybrid technologies that support circuit-switched packet-switched communications, as well as accessory interfaces such as USB, Firewire, and other existing and future wire-based connectivity technologies. The term “wireless” shall accordingly be taken to include, but not be limited to wireless communications using any number of wireless communication protocols or technologies. For example, wireless access technologies can include the family of 802 protocols defined by the Institute of Electrical and Electronics Engineers (IEEE) or long-range wireless access technologies such as, for example, cellular, software defined radio (SDR) and/or WiMAX. Cellular access technologies can include, for example, AMPS, CDMA-1X, UMTS/HSDPA, GSM/GPRS, TDMA/EDGE, EV/DO, and next generation technologies as they arise. Additionally, wireless communications can also include short-range wireless technologies such as optical or IR-based communications, WiFi, Bluetooth, Zigbee, cordless communications such as digital enhanced cordless telecommunications (DECT), or next generation technologies as they arise.

It is to be understood that a computer system can include any electronic device that provides voice, video or data communication. Further, while a single computer system is illustrated in FIG. 6, the phrase “computer system” shall be understood to include any collection of computing devices that individually or jointly execute a set (or multiple sets) of instructions to perform any one or more of the methodologies discussed herein.

### EXAMPLES

The following non-limiting Examples serve to illustrate selected embodiments of the invention. It will be appreciated that variations in proportions and alternatives in elements of the components shown will be apparent to those skilled in the art and are within the scope of embodiments of the present invention. Although the examples below will be described in terms of XML, JavaScript, and other particular computer languages, one of ordinary skill in the art will recognize that the various methods and systems described herein can also be implemented using any other type of programming language, scripting language, and/or web page authoring language.

### I. Template Authoring Example

In one exemplary implementation of an embodiment of the present invention, document templates are authored with software that produces XML output, which includes the document text in XHTML, and the logic in a combination of XML and JavaScript.

### II. Document Assembly Example

In this exemplary implementation, the document assembly system can be configured to split the document assembly process between a JavaScript Client (e.g., using generic JavaScript code) that runs within a web browser client on the end user terminal and an assembler application that resides on a server, such as web service application. The amount of processing on each side can vary, as previously described to reduced delays or latency. For example, the server can split the processing between the JavaScript client and the assembler, such that a significant proportion of the tasks are pushed to the JavaScript Client. This configuration facilitates real time document assembly and can operate as follows:
a. communication between the JavaScript Client and the assembler is done using an XMLHttp Request (XHR);
b. user requests an instance of the document template which has a unique ID;
c. assembler receives the request and receives generic JavaScript code providing the JavaScript client;
d. assembler gets the answers for this document instance from the database resident on the server (if any are available);
e. assembler sends an initial response and sends the document portions of the document template including the XHTML document text, JavaScript rules and validators, bookmarks, questions and cross references in addition the users answers are sent;
f. assembler informs the JavaScript Client if the user is qualified or unqualified. Qualified users are shown un-obscured document text while unqualified users are shown obscured document text;
g. the real time document is displayed as an XHTML document taking the text from the document portions of the document template at the start of the process. The JavaScript Client manages and updates the real time document for all but a number of functions which the assembler handles, this ensures fast updating as the client browser is handling the majority of the processing;
h. the assembler determines the next unasked question, using the logic in the document template. If there are no answers then the first question and group are selected;
i. the JavaScript client analyses all the rules and the answers then processes all the rules that are relevant to those answers;
j. the JavaScript Client manages the enabling and disabling of questions, enabling only the questions that have been referenced by document text, rules, conditions and other questions, thereby speeding up the process for the client processing; and
k. the assembler sends all the changes necessary to the document that is displayed, based on their answers.

Those paragraphs, sentences, words or characters obscured are tagged within the document template and used by the assembler or JavaScript Client to provide the same obscuring irrespective of resizing of the browser or addition/removal of document content. That is, the same obscured text remains obscured throughout the document assembly process for unqualified users.

In some implementations of the system described above, all the core functions are duplicated in both the JavaScript Client and the server side assembler. In this configuration, assembler can dynamically decide whether to execute a function on the end user terminal or the server. Less powerful computers would benefit from the processing being undertaken on the server while more powerful computers would improve performance by moving the majority of the processing to the end user terminal. This decision process works as follows:
a. a series of calculations that takes a known length of time on an end user terminal of a known performance level will be executed once before the assembly process begins. The assembly engine can determine, from the time taken to execute this function, how fast the end user terminal is; and
b. more code will be executed on the end user terminal if the end user terminal is fast, and more code will be executed on the server if the end user terminal is slow.
   Each assembly function, such as calculating which questions are enabled is graded according to the end user terminal performance that it requires. On the faster end user terminals, all assembly functions are performed on the end user terminal. A slightly slower end user terminal would result in the slowest assembly function being performed on the server instead. On the slowest end user terminal, all assembly functions being performed on the server.

While various embodiments of the invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to allow the reader to quickly ascertain the nature of the technical disclosure. It is submitted with the understanding that it will not be used to interpret or limit the scope or meaning of the following claims.

What is claimed is:

1. A method of configuring a document template in a document assembly system, the method comprising:
identifying one or more document portions for inclusion in the document template;
selecting at least one obscuring method for at least one of the document portions;
generating one or more obscuring parameters for the one document portion based on the selected obscuring method; and
storing a document template including the document portions and the obscuring parameters, wherein a document based on the document template is obscured according to the stored obscuring parameters during electronic publication.

2. The method of claim 1, wherein the identifying the document portions further comprises specifying at least one of document text fields, document non-text fields, and document generation fields.

3. The method of claim 1, wherein the selecting further comprises selecting at least one of an area obscuring method, a character obscuring method, and no obscuring method for the document portion.

4. The method of claim 3, wherein selecting the character obscuring method further comprises selecting at least one of a paragraph obscuring method, a sentence obscuring method, a word obscuring method, and a single character obscuring method.

5. The method of claim 1, wherein the generating further comprises:
selecting one or more sections of the one document portion to be obscured; and
selecting an overlaying technique for the selected sections.

6. The method of claim 5, wherein the selecting the sections further comprises selecting at least a pre-defined number of the sections of the one document portion.

7. The method of claim 6, wherein said overlaying technique is applied to at least the pre-defined number of sections.

8. The method of claim 5, where the selecting the overlaying technique comprises selecting one among an image applying technique and a character modifying technique.

9. The method of claim 5, wherein the selecting the overlaying technique comprises selecting one among covering the sections of the one document portion or replacing the sections of the one document portion.

10. The method of claim 1, further comprising:
prior to the storing the document template, altering at least one of the obscuring parameters based on at least one input from a user input device.

11. A method of assembling a document in a document assembly system, the method comprising:
selecting a document template, the document template including one or more document portions and one or more obscuring parameters associated with the document portions, the obscuring parameters specifying at least one obscuring method for at least one of the document portions;
assembling a user document based on the document template and at least one input from a user input device; and
electronically publishing the assembled user document, wherein the publishing comprises generating a modified version of the user document obscured based on the obscuring parameters and permissions provided by a user at the user input device.

12. The method of claim 11, wherein the obscuring method specifies at least one of an area obscuring method, a character obscuring method, and no obscuring method for the document portion.

13. The method of claim 12, wherein the character obscuring method for the one document portion further comprises at least one of a paragraph obscuring method, a sentence obscuring method, a word obscuring method, and a single character obscuring method.

14. The method of claim 11, wherein the obscuring method for the one document portion specifies one or more sections of the one document portion and an overlaying technique for the selected sections.

15. The method of claim 14, where the overlaying technique comprises at least one among an image applying technique and a character modifying technique.

16. The method of claim 14, wherein the overlaying technique comprises one among covering the sections of the one document portion or replacing the sections of the one document portion.

17. The method of claim 11, wherein the publishing further comprises:
generating at least one electronic image representing the modified version of the user document; and
electronically delivering the electronic image to a user output device.

18. The method of claim 11, further comprising:
detecting at least one of a change in the permissions and additional user input; and
repeating the assembling and the publishing based on the detecting.

19. A document assembly system, comprising:
a storage element for storing one or more document templates, the document templates comprising at least one document portion and one or more obscuring parameters associated with the document portion, the obscuring parameters specifying at least one obscuring method for the document portion; and
a processing element communicatively coupled to the storage element, the processing element configured for assembling a user document based on at least one of the document templates and at least one input from a user input device and electronically publishing the assembled user document, the published user document obscured according to the obscuring parameters associated with the template and permissions associated with the user input device.

20. The system of claim 19, wherein the obscuring method specifies at least one of an area obscuring method, a character obscuring method, and no obscuring method for the document portion.

21. The system of claim 20, wherein the character obscuring method for the document portion further comprises at least one of a paragraph obscuring method, a sentence obscuring method, a word obscuring method, and a single character obscuring method.

22. The system of claim 19, wherein the obscuring method for the document portion specifies one or more sections of the document portion to be obscured and at least one overlaying technique for the sections.

23. The system of claim 22, where the overlaying technique consists of one among an image applying technique and a character modifying technique.

24. The system of claim 19, wherein the processing element is further configured during the publishing for generating an image of the user document, and electronically delivering the image to a user output device.

25. The system of claim 19, wherein the processing element is further configured for detecting at least one of a change in the permissions and additional user input, and repeating the assembling and the publishing based on the detecting.

26. A document assembly method, the method comprising:
selecting a document template, the document template including one or more document portions and one or more obscuring parameters associated with the document portions, the obscuring parameters specifying at least one obscuring method for at least one of the document portions;
assembling a user document based on the document template and at least one input from a user input device; and
electronically publishing the assembled user document, wherein the publishing comprises generating an obscured version of the user document based on the obscuring parameters and permissions provided by a user at the user input device,
wherein the specified obscuring method replaces the document portions associated with the obscuring parameters with one or more obscuring features in the obscured version of the user document.
